(19) United States
(12) Patent Application Publication
(10) Pub. No.: US 2005/0041312 A1
(43) Pub. Date: Feb. 24, 2005

(54) Nonwoven web and method of making same

(76) Inventors: Sebastian Sommer, Troisdorf (DE); Udo Schomer, Urbach (DE); Jorg Willinger, Troisdorf (DE); Michael Block, Koln (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/912,740

(22) Filed: Jul. 30, 2004

(30) Foreign Application Priority Data
Aug. 8, 2003 (EP) 03018108.5

(51) Int. Cl. G02B 5/04

(52) U.S. Cl. 359/837; 359/834

(57) ABSTRACT

Spun-bond nonwoven material made of continuous filaments or fibers, whereby the continuous filaments or fibers are multi-component filaments, in particular bi-component filaments, with a low-melting component on the outer surface. The spun-bond nonwoven material is thermally bonded in a calender. The spun-bond nonwoven material has a mass per unit area of more than 40 g/m².

### FIELD OF THE INVENTION

The invention relates to a spun-bond nonwoven material made of continuous filaments or fibers, and to a method for the manufacture of such a spun-bond nonwoven material. The term “continuous fibers” and the term “filaments” mean, within the scope of the invention, threads or filaments which are theoretically of infinite length, from which the spun-bond nonwoven material is formed. A distinction is to be made between these and staple fibers, which are relatively short threads and in any event are on average much shorter than the filaments referred to heretofore. The filaments used according to the invention consist in particular of a thermoplastic material or thermoplastic materials.

### BACKGROUND OF THE INVENTION

From actual practice a large number of systems and methods are known for the manufacture of spun-bond nonwovens. The known spun-bond nonwovens, which consist in particular of monofilaments, leave a great deal to be desired with regard to their mechanical properties, especially in relation to tensile strength and energy storage (maximum tensile strength). This applies in particular to spun-bond nonwoven material of medium and heavy mass per unit areas from about 30 to 40 g/m².

Because of the limited thermal conductivity of the plastics used, it is difficult, during the thermal bonding of these spun-bond nonwovens with high mass per unit area, to provide a sufficient energy input into the center of the spun-bond nonwoven material. Nevertheless, the attempt is made to connect the filaments of the spun-bond nonwovens, during thermal bonding in a calender machine, as far as possible in each engraving point over the entire thickness of the spun-bond nonwoven material. This can lead to the surrounding area becoming brittle, however, which can result in the premature failure of the nonwoven material under mechanical stress.

With low mass per unit area, such as 17 g/m², with conventional materials such as polypropylene filaments and standard titers (1.8-2 denier), longitudinal strengths of up to some 50 N/5 cm are attained. The measurement of the longitudinal strengths is in this case effected in accordance with ISO 9073, Part 3. This corresponds to a specific strength of 2.94 N/5 cm: g/m² or N.m²/5 cm.g respectively. As the mass per unit area increases, however, the specific strength decreases, and falls to less than 2.5, and, as the mass per unit area values increase still further, drops as low as 2. By making use of finer filaments, it is indeed possible to improve the specific strength by a certain amount, but with higher mass per unit area values a specific strength exceeding 3 cannot be attained.

### OBJECTS OF THE INVENTION

It is the principal object of the invention to increase the strength and tensile strength respectively of spun-bond nonwoven materials and to obtain a higher mass per unit area value than 50 g/m².

Another object is to provide a method for the manufacture of such a spun-bond nonwoven material.

### SUMMARY OF THE INVENTION

These objects are attained with a spun-bond nonwoven material made of continuous filaments or fibers, whereby the continuous filaments or fibers are multi-component filaments, in particular bi-component filaments, with at least one low-melting component on the outer surface.

The spun-bond nonwoven material is one which has been thermally bonded in a calender with an embossing surface of less than 22%.

The spun-bond nonwoven material has a mass per unit area of over 50 g/m².

The embossed or embossing surface of the calender means the ratio of the effective surface area which, during the thermal bonding, produces the connection points in the spun-bond nonwoven material or between the filaments respectively to the entire calender area juxtaposed with the web or mat. In other words, this is the surface which takes effect directly on the filaments. As a rule, the embossed surface is formed from embossing points of the embossing cylinder of the calender. It falls within the scope of the invention that an embossing cylinder-smoothing cylinder pair is used as the calender. It falls within the scope of the invention that the spun-bond nonwoven material is thermally bonded in a calender with an embossing surface ratio of at least 10%, and for preference at least 12%.

Within the scope of the invention, it is to the purpose for filaments to be used with titer values of between 1.8-2.5 denier. It is also possible for finer filaments to be used, however: in principle, therefore, filaments are to be used within the scope of the invention with titers of between 0.8 to 2.5 denier.

The filaments used according to the invention consist for preference of a low-melting component, which is arranged on the outer surface of the filament, and a component with a higher melting point, which forms the core of the filament. According to a highly preferred embodiment of the invention, the multi-component filaments used according to the invention, in particular bi-component filaments, have a core-sheath structure and in this context the low-melting component forms the sheath. The minimum of one higher-melting component, by contrast, forms the core of the filament. With a filament with a core-sheath structure, the core can be completely surrounded by the sheath formed of the low-melting component. In addition both the core and the sheath can extend over the entire length of a filament.

According to a particularly preferred embodiment of the invention, the low-melting component has a melting point which is at least 5° C. lower than the melting point of the higher-melting component, for preference at least 10° C. lower, and for particular preference at least 15° C. lower. To the purpose, the melting point of the low-melting component lies at least 20° C. lower than the melting point of the higher-melting component. For preference, the melting point of the low-melting component is about 120° C. and higher.

According to a preferred embodiment of the invention, the low-melting component is a polyolefin or a mixture of polyolefins and their copolymers. According to one embodiment of the invention, the low-melting component is polyethylene and the higher-melting component is polypropylene. In this situation, polypropylene therefore forms the sheath of a core-sheath structure, and polypropylene forms the core of the filament.

According to another embodiment of the invention, the low-melting component is a polypropylene-copolymerizate, of which the weakening point or melting point is lower than that of pure polypropylene. With this latter embodiment, the higher-melting component consists to the purpose of polypropylene. With this embodiment, too, it is to the purpose for a core-sheath structure to be formed, whereby the polypropylene-copolymerizate forms the sheath and the polypropylene forms the core of the filament. The polypropylene-copolymerizate is preferably a polypropylene-polyethylene copolymer. This copolymer can be heteroplastic. It is also within the scope of the invention, for example, for non-heteroplastic polypropylene-polyethylene copolymers to be used, which can contain, polyethylene proportions of 2 to 6% by weight.

According to one embodiment of the invention, instead of the polypropylene copolymerizate, a polypropylene terpolymerizate can also be used as the low-melting component, whereby this is preferably a polypropylene-polyethylene-polybutylene terpolymer. According to a further embodiment of the invention, it is possible to use polyethylene or polypropylene as the low-melting component, and a polyester as the high-melting component. With a preferred core-sheath structure, the polyethylene or polypropylene respectively forms the sheath, and the polyester forms the core.

It falls within the scope of the invention for the portion of the low-melting component in the filaments to amount to 10 to 40% by weight, and for preference 15 to 35% by weight. In this situation, the percentage by weight data relates to the entire filament. The portion of the higher-melting component amounts accordingly, for preference, to 90 to 60% by weight, and more preferably 85 to 65% by weight.

To the purpose, the spun-bond nonwoven material according to the invention is a spun-bond nonwoven which is thermally bonded in a calender with an embossing surface ratio of less than 20%. According to a particularly preferred embodiment of the invention, the spun-bond nonwoven exhibits a mass per unit area of more than 60 g/m².

To resolve the technical problem, the invention further teaches a method for the manufacture of a spun-bond nonwoven material, whereby a nonwoven mat is formed from continuous filaments, formed in turn as multi-component filaments, in particular as bi-component filaments, said continuous filaments exhibiting a low-melting component on its outer surface, whereby the nonwoven mat is thermally bonded in a calender with am embossed surface of less than 22%, and whereby a spun-bond nonwoven material is produced with a mass per unit area of more than 50 g/m².

With the aid of the calender, connection points are produced between the filaments. Within the scope of the invention, “connection points” are the areas of the filaments which are softened due to the effect of the calender, and at which connection areas with adjacent filaments are formed. In one embodiment of the invention, at the connection points only the outer areas of a filament in relation to the filament cross-section are softened, and a core area is not softened and remains free of softening. This possibility arises in particular if the melting point difference is relatively high in relation to the low-melting and the higher-melting component, i.e., for example with a polyolefin as the low-melting component and a polyester as the higher-melting component.

According to one embodiment of the invention, in this situation only the outer surface or the sheath, made of the low-melting component, is softened or melted at least in part, and the core, made of the higher-melting component, remains entirely free of softening. It is also within the scope of the invention that the outer surface or the sheath, made of the low-melting component, is softened or melted, and that only surface areas of the core are softened or melted, and the core otherwise remains essentially free of softening.

A highly preferred embodiment of the invention is characterized in that the thermal bonding is carried out with the principle that the higher-melting component in the area of the connection points or at the connection points remains entirely or essentially free of softening. Essentially free of softening means that, for preference, in relation to the cross-section of the filament at the connection point, 75 to 90% by weight of the higher-melting component remains free of softening.

The invention is based on the finding that, due to the embodiment of the spun-bond nonwoven material according to the invention, or the filaments of the spun-bond nonwoven material according to the invention respectively, during the thermal bonding the energy application extends into the middle of the nonwoven material, in order to connect the filaments across the low-melting outer material. On the other hand, no disadvantageous thermal impairment of the other filament areas takes place. As a result the spun-bond nonwoven material according to the invention is characterized by a surprisingly high strength or tensile strength. It is possible to manufacture spun-bond nonwoven materials with high mass per unit area values, of more than 50 g/m², and more particularly of more than 60 g/m², which exhibit such surprisingly high strength or tensile strength. Specific longitudinal strengths of higher than 3 are achieved with these high mass per unit area values.

### EXAMPLES

The invention is explained in greater detail hereinafter on the basis of embodiments:

### Example 1

A spun-bond nonwoven material was manufactured from bi-component filaments, whereby the filaments exhibited a standard titer (1.8 to 2 denier). The bi-component filaments had a core-sheath structure, and specifically a core of polypropylene and a sheath of a polypropylene copolymerizate, of which the melting point is lower in comparison with the polypropylene in the core. The polypropylene copolymerizate was a heteroplastic polypropylene-polyethylene copolymer. The proportion of the core component was 80% by weight and the proportion of the sheath component 20% by weight. The spun-bond nonwoven material manufactured had a mass per unit area of 60 g/m². The thermal bonding was carried out according to the invention with an embossing calender. A longitudinal strength of 220 N/5 cm was achieved, and a specific longitudinal strength of 3.6.

### Example 2

A spun-bond nonwoven material was manufactured from bi-component filaments with standard titer. The bi-component filaments exhibited a core-sheath structure. The core component was polypropylene and the sheath component was polyethylene. The proportion of the core component was 70% by weight and the proportion of the sheath component was 30% by weight. The spun-bond nonwoven material had a mass per unit area of 55 g/m². This spun-bond nonwoven material was also thermally bonded with a calender according to the invention. A longitudinal strength of 220 N/5 cm was attained, and a specific longitudinal strength of 4.

### Example 3

With this embodiment too, a fine-fiber nonwoven material was manufactured from bi-component filaments with a titer of 1.1 denier, which exhibited a core-sheath structure. The core consisted of polypropylene and the sheath of polyethylene. The proportion of the core component was 70% by weight and the proportion of the sheath component 30% by weight. The fine fibre nonwoven material had a mass per unit area of 55 g/m². After the thermal bonding with a calender according to the invention, a longitudinal strength of 280 N/5 cm was determined, and a specific longitudinal strength of 5.1.

### BRIEF DESCRIPTION OF THE DRAWING

The above and other objects, features and advantages of the present invention will become more readily apparent from the following description, reference being made to the accompanying drawing in which:

FIG. 1 is a cross sectional view through a filament as used in accordance with the present invention;

FIG. 2 is a diagrammatic perspective view showing two bi-component filaments fused together at a crossover;

FIG. 3 is a cross section through the embossing calender roller, the opposing roller having a smooth surface;

FIG. 4 is a plan view onto the embossing roll surface; and

FIG. 5 is a diagrammatic cross section through an apparatus for producing the nonwoven web according to the invention.

### SPECIFIC DESCRIPTION

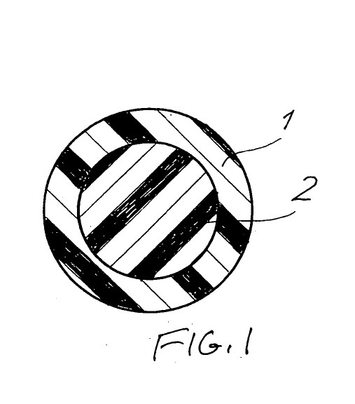

FIG. 1 shows a cross-section through a bi-component filament according to the invention, with a core-sheath structure. The sheath 1, which for preference and in the embodiment example shown, completely surrounds the core, consists, for example, of polyethylene or of polypropylene copolymerizate. The core 2, completely surrounded by the sheath 1, may consist of polypropylene in the embodiment shown. According to another embodiment, however, this core 2 can also consist of a polyester or another plastic, with a higher softening temperature in relation to the sheath component.

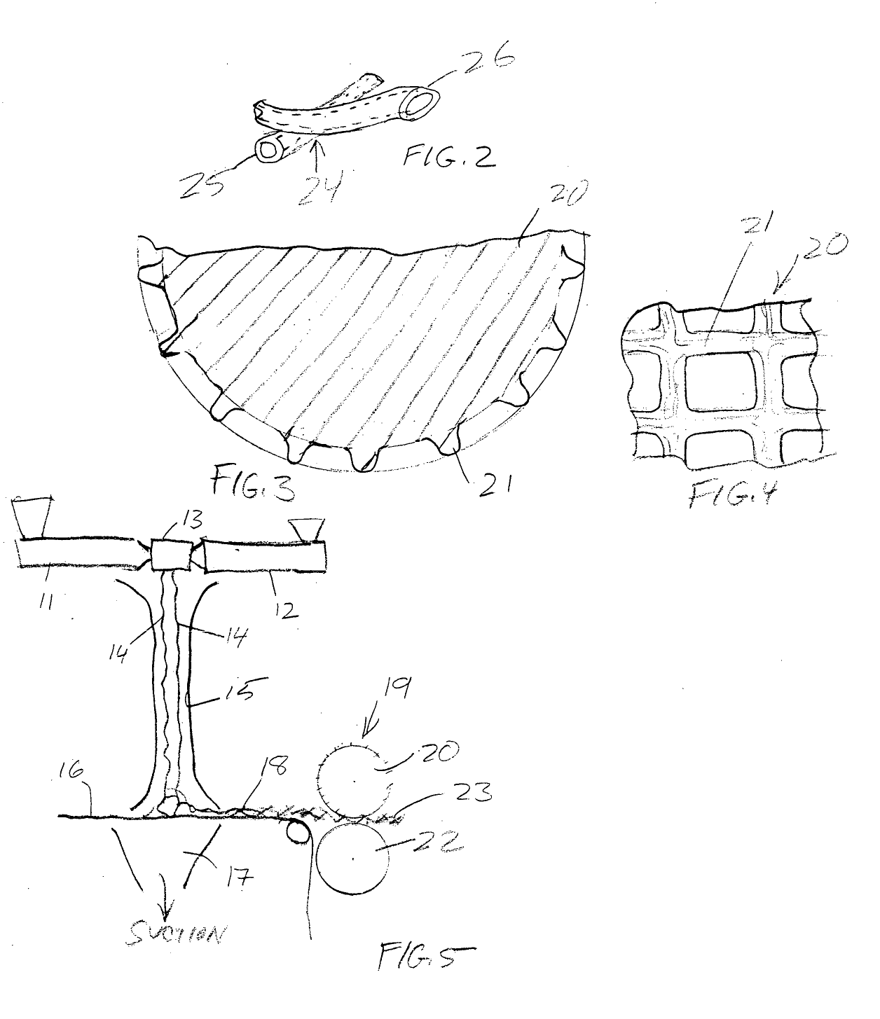

Referring now to FIG. 5, it can be seen that the basic apparatus for producing the nonwoven web of the invention is that of a spun-bond apparatus with, however, two extruders or screw-type plasticizing units 11 and 12 for the two components of the filaments working into a spinneret 13 from which the bi-component filament 14 emerge each with a core of a higher softening temperature and a sheath of a lower softening temperature. The filaments can be aerodynamically stretched in a sheath 15 and collect in a jumble on a perforated endless belt 16 above a suction chamber 17. The resulting spun-bond nonwoven web 18 passes to a calender 19 having-a roll 20 provided with embossing formations 21 (see FIGS. 3 and 4), and a smooth surface roller 22. The embossing formations are so arranged that they provide an embossing surface, i.e. a surface of roller 20 in contact with the nonwoven web which is less than 22% of he entire surface of roll 20 juxtaposed with the web. The spun-bond nonwoven material at 23 has a mass per unit area in excess of 50 g/m².

The embossing ridges 21 thus press crossovers 24 (FIG. 2) together to cause bonding of the sheaths of crossing filaments 25, 26 at a softening temperature of those sheaths to effect fusion between the filaments at those crossovers at which the embossing ridges 21 are effective. The calender rolls 20 and 22 can be heated if the residual heat in the fibers is insufficient to maintain the softening temperatures of the sheaths.

1. A spun-bond nonwoven web comprised of multicomponent synthetic resin filaments having a low-melting component upon outer surfaces and filament crossings at which the low-melting components of the filaments are fused together, a mass per unit area of the web in excess of 50 g/cm², and thermally bonded in a calender with an embossing surface ratio, defined as the ratio of area of the calender which effects thermal bonding of the filaments together to the total area of the calender juxtaposed with the web, of less than 22%.

2. The spun-bond nonwoven web defined in claim 1 wherein said filaments have a core/sheath structure and said low-melting component forms a sheath for the filaments.

3. The spun-bond nonwoven web defined in claim 2 wherein the low-melting component has a melting point at least 5° C. lower than the melting point of the cores of the filaments.

4. The spun-bond nonwoven web defined in claim 3 wherein the low-melting component is a polyolefin.

5. The spun-bond nonwoven web defined in claim 4 wherein the low-melting component constitutes 10 to 40% by weight of the filament.

6. The spun-bond nonwoven web defined in claim 5 wherein the low-melting component constitutes 15 to 35% by weight of the filament.

7. The spun-bond nonwoven web defined in claim 6 wherein the web is thermally bonded in a calender with an embossing surface ratio of less that 20%.

8. The spun-bond nonwoven web defined in claim 7 having a mass per unit area in excess of 60 g/m².

9. The spun-bond nonwoven web defined in claim 1 wherein the low-melting component has a melting point at least 5° C. lower than the remainder of the filament.

10. The spun-bond nonwoven web defined in claim 1 wherein the low-melting component is a polyolefin.

11. The spun-bond nonwoven web defined in claim 1 wherein the low-melting component constitutes 10 to 40% by weight of the filament.

12. The spun-bond nonwoven web defined in claim 1 wherein the low-melting component constitutes 15 to 35% by weight of the filament.

13. The spun-bond nonwoven web defined in claim 1 wherein the web is thermally bonded in a calender with an embossing surface ratio of less that 20%.

14. The spun-bond nonwoven web defined in claim 1 having a mass per unit area in excess of 60 g/m².

15. A method of making a spun-bond web, comprising the steps of:
forming a mass of synthetic resin filaments having a low-melting synthetic resin component of surfaces of said filaments;
collecting said mass of filaments in a nonwoven spun-bond mat; and
thermally bonding said nonwoven spun-bond mat in a calender with an embossing surface ratio, defined as the ratio of area of the calender which effects thermal bonding of the filaments together to the total area of the calender juxtaposed with the web, of less than 22% to produce a web having a mass per unit area of the web in excess of 50 g/cm².

16. The method defined in claim 15 wherein said filaments are formed with a core/sheath structure and said low-melting component forms a sheath for the filaments.

17. The method defined in claim 16 wherein the sheaths are provided from a synthetic resin which has a melting point at least 5° C. lower than the melting point of the cores of the filaments.

18. The method defined in claim 17 wherein the sheaths are provided from a polyolefin.

19. The method defined in claim 18 wherein the filaments are so formed that the low-melting component constitutes 10 to 40% by weight of the filament.

20. The method defined in claim 19 wherein the web is formed in said calender to a mass per unit area in excess of 60 g/m².
